(19) United States
(12) Patent Application Publication
(10) Pub. No.: US 2017/0192965 A1
(43) Pub. Date: Jul. 6, 2017

(54) METHOD AND APPARATUS FOR SMART ALBUM GENERATION

(71) Applicant: Synchronoss Technologies, Inc., Bridgewater, NJ (US)

(72) Inventor: Thomas P. Loscalzo, Stewartsville, NJ (US)

(21) Appl. No.: 15/388,455

(22) Filed: Dec. 22, 2016

Related U.S. Application Data
(60) Provisional application No. 62/272,781, filed on Dec. 30, 2015.

(51) Int. Cl. G06F 17/30; G06T 1/00; G06K 9/00

(52) U.S. Cl. CPC G06F 17/3002; G06K 9/00288; G06T 1/0007; G06F 17/30029

(57) ABSTRACT

A computer implemented method and apparatus for generating smart albums. The method comprises performing image analysis on a plurality of media files on a first user device, wherein each of the plurality of media files includes metadata; updating metadata associated with each of the plurality of media files based on the image analysis; transmitting the plurality of media files and updated metadata to a media sharing server; receiving, in response to transmitting the plurality of media files, one or more media files created by other users, wherein the metadata associated with the received media files is similar to the metadata associated with the transmitted media files; and generating a plurality of albums based on a comparison of metadata of the transmitted and received media files.

### CROSS REFERENCE TO RELATED APPLICATIONS

This application claims benefit of U.S. Provisional Application Ser. No. 62/272,781, filed Dec. 30, 2015, which is herein incorporated by reference in its entirety.

### BACKGROUND OF THE INVENTION

Field of the Invention

Embodiments of the present invention generally relate to media processing and, more particularly, to techniques for smart album generation.

Description of the Related Art

With the ubiquity of cell phones and digital cameras, people are able to take and store a significant amount of media (e.g., images and videos). In addition, people can share media on social media or by sending the media using a multimedia message server (MMS), email, and the like.

Today, albums are automatically generated based on date information associated with the media. However, in order to create a more custom album, a user must access each image and/or video in order to create a desirable album of images and video. Analyzing the volume of media is time-consuming compounded by the often daily addition of new media received on a device. In addition, when a user attends an event, the only way to include the images and videos of other attendees is to request that the images and/or video be sent to the user.

Therefore, there is a need for a method and apparatus for smart album generation.

### SUMMARY OF THE INVENTION

A method and apparatus for smart album generation is provided.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

A method for generating smart albums is described. The method comprises performing image analysis on a plurality of media files on a first user device, where each of the plurality of media files includes metadata, and updating metadata associated with each of the plurality of media files based on the image analysis. The plurality of media files and updated metadata is transmitted to a media sharing server and in response to transmitting the plurality of media files, receiving one or more media files created by other users, where the metadata associated with the received media files is similar to the metadata associated with the transmitted media files. Finally, a plurality of albums is generated based on a comparison of metadata of the transmitted and received media files.

In another embodiment, an apparatus for generating smart albums is described. The apparatus includes at least one processor, at least one input device, and at least one storage device storing processor-executable instructions which, when executed by the at least one processor, perform the method for generating smart albums.

In yet another embodiment, a non-transitory computer readable medium for generating smart albums is described. The computer readable medium stores computer instructions that, when executed by at least one processor causes the at least one processor to perform the method for generating smart albums.

Other and further embodiments of the present invention are described below.

### BRIEF DESCRIPTION OF THE DRAWINGS

FIG. 1 is a block diagram of a system for smart album generation, according to one or more embodiments;

FIG. 2 depicts a flow diagram of a method for smart album generation, according to one or more embodiments;

FIG. 3 depicts a flow diagram of a method for generating metadata for a media file, according to one or more embodiments;

FIG. 4 depicts a flow diagram of a method for generating smart albums by comparing the metadata of a plurality of media files, according to one more embodiments; and

FIG. 5 depicts a computer system that can be utilized in various embodiments of the present invention to implement the computer and/or the display, according to one or more embodiments.

While the method and apparatus is described herein by way of example for several embodiments and illustrative drawings, those skilled in the art will recognize that the method and apparatus for smart album generation is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for smart album generation defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for smart album generation. An album is a collection of related media files. A smart album is a collection of related media files that are automatically generated based on common metadata associated with the media files. A plurality of smart albums is generated using media files from a user device in addition to media files of other users downloaded from a service provider server. Media files may be cropped, resampled, transcoded, color corrected or created as photo images extracted from a video stream. In addition, media files may be compressed in order to reduce the file size. Media files are then analyzed to perform object detection, facial recognition, image quality analysis, subject identification, and the like. Analysis data for an image or video is added to the metadata of the media file. The media files are transmitted and stored at a server. The metadata of the media files is compared to metadata of media files of other users on the server. Media files that have metadata that matches those of the user are downloaded to the user device. For example, if the metadata associated with a media file on the server indicates that an image includes a same group of subjects, is taken at a same date and timeframe, and in a same location as the user's media file, then the media file is transmitted to the user device for inclusion in the user's albums. As such, albums may include media files taken by the user as well as media files of other users.

Various embodiments of a method and apparatus for smart album generation are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

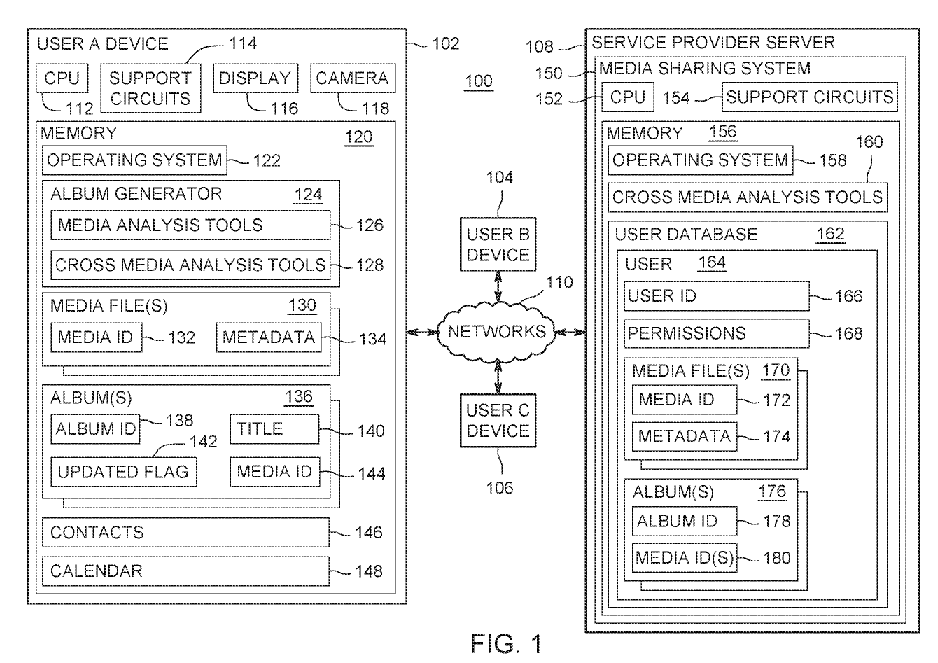

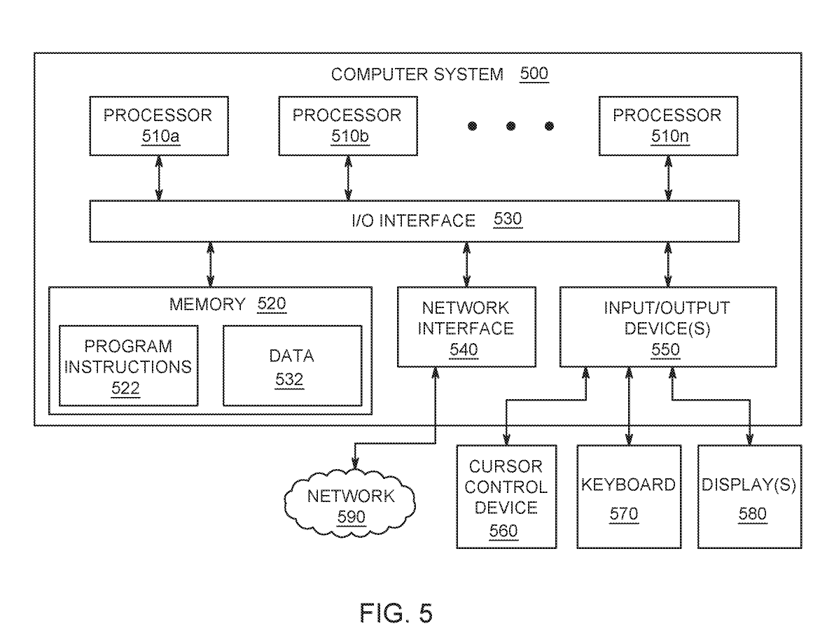

FIG. 1 is a block diagram of a system 100 for a smart album generator, according to one or more embodiments. The system 100 includes multiple user devices, for example user A device 102, user B device 104, user C device 106, and a service provider server 108 communicatively coupled to one another via a network 110. The user devices 102, 104, and 106 are a type of computing device for example, a mobile device, a desktop computer, laptop, tablet computer, and the like each associated with a different user. One example of a suitable computer is shown in FIG. 5, which will be described in detail below. The service provider server 108 may be a cloud services provider.

Each user device 102, 104, and 106 includes a Central Processing Unit (CPU) 112, support circuits 114, a display 116, a camera 118, and a memory 120. The CPU 112 may include one or more commercially available microprocessors or microcontrollers that facilitate data processing and storage. The various support circuits 114 facilitate the operation of the CPU 112 and include one or more clock circuits, power supplies, cache, input/output circuits, and the like. The camera 118 may include a front camera and a back camera as is typically found on a smart phone. The memory 120 includes at least one of Read Only Memory (ROM), Random Access Memory (RAM), disk drive storage, optical storage, removable storage and/or the like.

The memory 120 includes an operating system 122, an album generator 124, a plurality of media files 130, a plurality of albums 136, contacts 146, and a calendar 148. The album generator 124 includes media analysis tools 126 and cross media analysis tools 128. Each media file 130 includes a media identifier (ID) 132 and metadata 134. Each album 136 includes an album ID 138, a title 140, an update flag 142 to indicate whether the album has been updated since the album 136 was last viewed, and a plurality of media IDs 144 that are associated with media files 130 that make up the album 136.

The service provider server 108 is a computing device, for example, a desktop computer, laptop, tablet computer, and the like, or it may be a cloud based server (e.g., a blade server, virtual machine, and the like). One example of a suitable computer is shown in FIG. 5, which will be described in detail below. According to some embodiments, the service provider server 108 includes a Central Processing Unit (CPU) 152, support circuits 154, and a memory 156. The memory 156 includes an operating system 158, cross media analysis tools 160, and a user database 162. The user database 162 stores the media files 170 of users supported by the service provider. The user database 162 includes a plurality of users 164, where each of the plurality of users 164 includes a user ID 166, permissions 168, media files 170, and albums 176 that were uploaded from the user devices 102, 104, and 106. As on the user devices 102, 104, and 106, each media file 170 includes a media ID 172 and metadata 174, and each album 176 includes an album ID 178, and multiple media IDs 180 that are associated with media files 170 that makeup the album 176.

The CPU 152 may include one or more commercially available microprocessors or microcontrollers that facilitate data processing and storage. The various support circuits 154 facilitate the operation of the CPU 152 and include one or more clock circuits, power supplies, cache, input/output circuits, and the like. The memory 156 includes at least one of Read Only Memory (ROM), Random Access Memory (RAM), disk drive storage, optical storage, removable storage and/or the like.

The user devices 102, 104, and 106, and the service provider server 108 may be connected to external systems via a network 110, such as a Wide Area Network (WAN) or Metropolitan Area Network (MAN), which includes a communication system that connects computers (or devices) by wire, cable, fiber optic and/or wireless link facilitated by various types of well-known network elements, such as hubs, switches, routers, and the like. The network interconnecting some components may also be part of a Local Area Network (LAN) using various communications infrastructure, such as Ethernet, Wi-Fi, a personal area network (PAN), a wireless PAN, Bluetooth, Near field communication, and the like.

Each of the plurality of media files 130 is accessed on a user device, for example user A device 102. The media file 130 may be an image, a video, and the like. The media file 130 may be created using either the front or back camera of the camera 118 on the user A device 102 or received from another device for example, in a MMS message, in an email message from another user, transferred to the user device 102 from another user device, and the like. Each media file 130 is processed individually. Optionally, the media file 130 may be optimized based on device width, pixel density, image formats, and the like. In some embodiments, the image is compressed to reduce the file size. The media analysis tools 126 access the metadata 134 associated with the media file 130. Typical metadata 134 that is generated for a media file 130 when it is created includes a date/time the media file 130 was created (or start and stop time if the media file is a video) and a longitude/latitude of the location where the media file 130 was created based on the Global Positioning System (GPS) on the user device 102 that created the media file 130.

Based on the longitude and latitude in the metadata, a reverse geocode lookup may be performed using for example, a GOOGLE® Maps application programming interface (API) to determine an address (e.g., city, state, street, location name, etc.) associated with the longitude and latitude. The owner of the user device 102 may be retrieved and stored as the photographer (i.e., creator of the media file). The image quality of the media file 130 may be analyzed based on sharpness/focus, color vibrancy, lighting, and the like, to determine ratings for the quality of the media file 130. Image quality analysis may be performed by any well-known techniques known in the art. The media file 130 may then be analyzed to determine what objects and/or people are included in the media file 130. For example, the media file 130 is analyzed using any facial recognition software known in the art to determine whether there are faces in the media file 130. Further it is determined how many faces exist in the media file 130. The facial recognition software may determine whether the faces are smiling, looking at the camera, are in profile, whether the faces have facial hair, tattoos, earrings, and the like. An age and sex estimation is performed on each determined face. The media analysis tools 126 also determine whether one or more of the faces or objects are the subject of the media file 130. The media file 130 is analyzed in order to determine other objects are included in the media file 130, for example, trees, balloons, gifts, and the like. The identified faces and objects in the media file 130 are compared to previously identified faces and objects in order to add identifying information associated with the people and objects in the media file 130. For example, a media file 130 that includes a man and a dog. Contact information in contacts 146 on the user device may include a photo of John and his dog Bear. If the face in the media file matches the photo of John, the man may be identified as John (the man). Similarly, the photo of John's dog Bear is compared to the dog in the media file 130, such that Bear may be identified by name. Lastly, it is determined whether the media file 130 has been shared, either via texting, email, social media, and the like. All of the information determined based on the analysis of the media file 130 is added to the metadata 134 of the media file 130.

The analyzed media files 130 are uploaded from user A device 102 as are the analyzed media files from the devices of other users, for example user B device 104 and user C device 106. The media files 130 from the user devices are stored in the user database 162, where each user 164 has a previously assigned user ID 166 and permissions 168 that indicate whether the user 164 allows sharing of the user's media files 170. When the media files 130 are uploaded from user A device 102, the cross media analysis tools 160 compare the metadata of the media files 130 from user A device 102 to the metadata 174 of media files 170 of other users 164. Any media files 170 that share the same information in their metadata as the media files 130 that were uploaded from user A device 102 are downloaded to the user A device 102 to be included in the album generation on user A device 102. When the media files 170 of other users are received on the user A device 102, the downloaded media files 170 may be stored as media files 130 on the user device 102.

Next, a plurality of albums 136 is generated. Each album 136 is made up of a plurality of media files 130 with matching metadata 134. Upon generation, each album 136 is assigned an album ID 138, a title 140, a boolean update flag 142 that initially indicates that the album 136 has been updated, and a plurality of media IDs 144 that are associated with the media files 130 that make up the album 136. The metadata 134 of each of the media files 130 is compared to one another and media files 130 with matching information in their metadata 134 may be included together in an album 136. An album 136 of selfies may be generated. For example, media files 130 that include metadata 134 indicating media files 130 include the user as the primary subject (e.g., more than 50% of the image is of the user's face) and possibly metadata indicating the image was taken with the front device camera 118 are included in the selfie album 136.

In some embodiments, a number of media files 130 per album 136 may be limited to a pre-defined quantity. In such case, the media files 130 are selected based on image quality ratings that are stored in the metadata 134, a number of shares of the media file 130, and the like, with more recent media files 130 being included before older media files 130. In addition, media files 130 that are almost identical, for example a burst of images taken within seconds of one another may be reduced to include only one of the images in order to reduce the quantity of media files 130 in the album 136. The media IDs 144 associated with the media files 130 that are to be part of the album 136 are stored with the album 136. In addition, a title 140 may be assigned to the album 136, for example, “Selfies”. An album 136 of smiling selfies may be generated that includes media files 130 of the user associated with the user device 102 that have been determined, based on the facial recognition software, to include the user as the primary subject and smiling.

Similarly, an album 136 of media files 130 that include an identified subject may be generated. For example, the metadata 134 for a plurality of media files 130 may indicate a same subject, for example a Grandpa Joe. An album 136 of the identified subject may be generated.

One or more albums 136 of parties may be generated. Cross media analysis tools 128 may identify a plurality of media files 130 have metadata that indicates the media files 130 include for example, a same group of people, taken at a same date and timeframe, at a same location, and where objects in the media files 130 include objects such as balloons, party hats, gifts. Such objects indicate that the media files 130 were created at a party. Due to the fact that the media files 170 were downloaded from the service provider server 108, the party albums include images and/or video taken by the user, as well as images and/or video taken by other attendees at the party.

One or more vacation albums 136 may be generated. For example, the metadata 134 may indicate that a plurality of media files 130 were generated at a location that is at least a pre-defined distance, for example 100 miles, away of the user's home location. In addition, it may be determined that the plurality of media files 130 at said location was generated over specific timeframe, for example a number of days. Further, the reverse geocode lookup may indicate a tourist location rather than a street address, for example, The Grand Canyon. In some embodiments, image recognition software tags indicate a vacation destination. In some embodiments, a database of public locations may be accessed to retrieve additional media files of the vacation destination to include in the vacation album.

One or more albums 136 associated with calendar events may be generated. The album generator accesses calendar 148, where holidays and events are stored. An album 136 may be generated for each event that coincides with the dates when pictures or videos were taken. For example, a New Year's Eve album 136 may be generated to include media files 130 taken within the timeframe for example, 5 pm through 6 am on New Year's Eve. A New Year's Day album 136 may be generated to include media files 130 taken between for example, 6 am and 11:59 pm on New Year's Day.

Other albums 136 may be generated, for example an album of the last 25 media files created may be generated. An album of the best 25 media files may be generated. Any albums 136 may be generated based on similar information stored in the metadata 134 of media files 130.

Once generated, albums 136 may be updated based on a trigger. For example, when new media files 130 are taken, the media files 130 are analyzed. Albums 136, such as the last 25 generated media files 130, are updated and an update flag 142 is set to indicate that the album 136 has been updated since it was last viewed. If the metadata 134 indicates that the media file 130 was generated at a same vacation location as the previous day's media files 130, said media file 130 is added to the vacation album 136. Similarly, additions or updates may be made to the selfie albums 136 if the metadata 134 for the new media files 130 indicates that the primary subject of an image is the user. Any new media file 130 that includes metadata 134 similar to that in an already created album 136 may be used to update the album 136.

When viewing the albums 136, a user may select a media file 130 in an album 136. Options are displayed on display 116 to allow the user to, for example, print the media file 130 or album 136, share the media file 130 or album 136, view all albums 136 that include a specific media file 130, and the like.

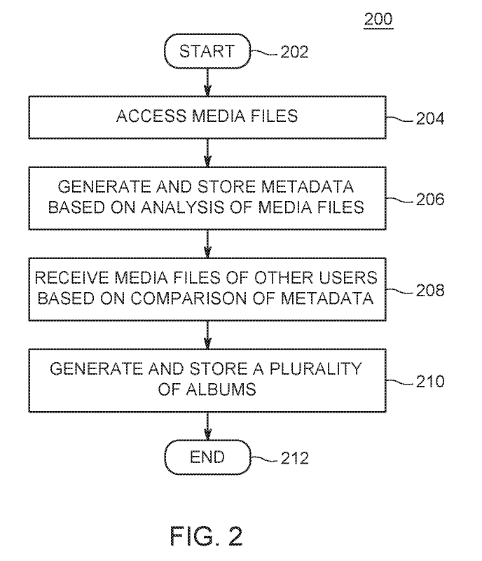

FIG. 2 depicts a flow diagram of a method 200 for smart album generation, according to one or more embodiments. The method 200 starts at step 202 and proceeds to step 204.

At step 204, the media files on a user device are accessed. The media files include metadata, for example a date and time the media file was generated. In the case where a media file is a video, the metadata includes a start date and time and a stop date and time. The metadata also includes a longitude/latitude of the location where the media file was created. The longitude and latitude are determined using the Global Positioning System (GPS) on the device on which the media file was generated.

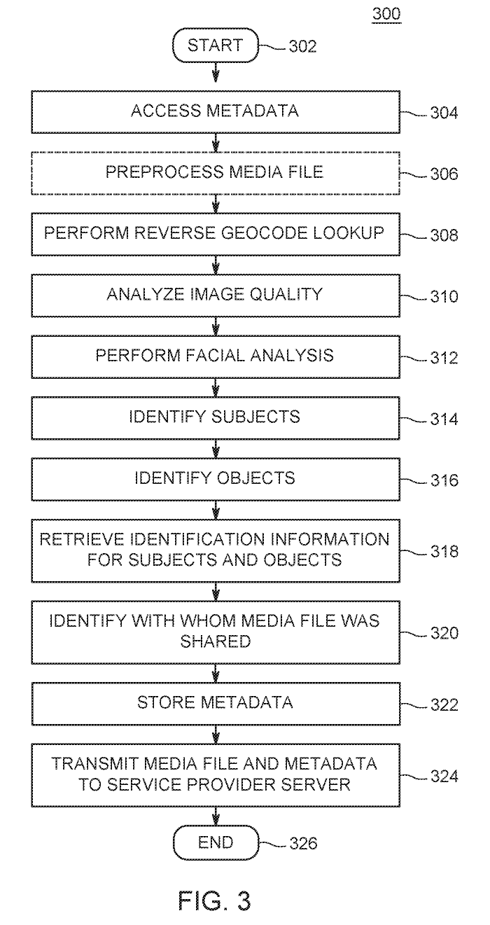

At step 206, metadata for each media file is generated and stored based on an analysis of the media files. Each media file is analyzed using a plurality of image analysis tools, as described in further detail with respect to FIG. 3 below. The media files and their associated metadata are transmitted to a media sharing server for comparison with the media files of other users.

At step 208, media files of other users are received from a media sharing server. A plurality of media files that are determined to share similar or identical metadata as the media files transmitted from the user device are received from the server. The received media files belong to other users; however, the media files include for example, a same subject(s), were taken at a same date/timeframe/location, and the like as one or more of the media files transmitted from the user device.

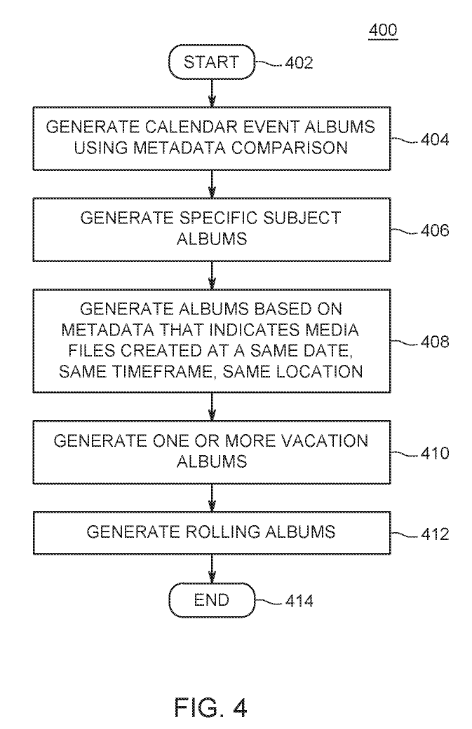

At step 210, a plurality of albums is generated and stored. The plurality of albums is generated based on compared metadata, as described in further detail with respect to FIG. 4 below. Each of the plurality of albums may include media files created by the user as well as media files of other users that were downloaded from the server. The method 200 ends at step 212.

FIG. 3 depicts a flow diagram of a method 300 for generating metadata for a media file, according to one or more embodiments. The method 300 is performed on each media file accessed in step 204 of FIG. 2. The steps of method 300 need not be performed in the order described below. The media file processing and image analysis steps may be performed in any order. The method 300 starts at step 302 and proceeds to step 304.

At step 304, the metadata of a media file is accessed. The metadata includes at least a media file generation date/time and a longitude/latitude where the media file was created.

At step 306, the media file may optionally be pre-processed. Pre-processing may include, but is not limited to, optimizing the media file based on device width, pixel density, and file format. If the media file is an image, the image may be cropped, rotated, and the like. Optimizing the media file may be performed using third-party media processing software known in the art. Metadata is generated to indicate that the file was pre-processed. Alternately, or in addition to preprocessing, the media file may be compressed to reduce the amount of memory that is required to store the media file. Metadata is generated to indicate that the media file was compressed.

At step 308, a reverse geocode lookup is performed. The latitude and longitude where the media file was generated is retrieved from the metadata. A reverse geocode lookup may be performed using for example, a GOOGLE® Maps application programming interface (API) to determine an address (e.g., city, state, street, location name, etc.) associated with the longitude and latitude. Metadata is generated to include the address where the media file was created.

At step 310, the image quality of the media file is analyzed. If the media file is a video, then each frame of the video file may be analyzed. Image quality metrics are determined based on image sharpness/focus, color accuracy and uniformity, defective pixel detection, dust and particle detection, temporal/fixed pattern noise, and the like. Image quality analysis may be performed using third-party software known in the art. In some embodiments, metrics are stored for a plurality of quality readings. In some embodiments, a single overall image quality score is determined. Metadata is generated to include the quality metrics.

At step 312, facial analysis is performed on the media image in order to determine how many people are in the image, determine a facial expression for each person, determine a sex and age of each person, and the like. Facial analysis may be performed using third-party software known in the art. Metadata is generated to include information determined by the facial analysis.

At step 314, additional subjects in the media file are identified. For example, the subject of a media file may be a specific person or a dog. While a media file may include six faces, only one may be the subject of the image based on where the subject is placed in the image, what percentage of the image is taken up by the subject and the like. One or more subjects of the media file may be determined using third party software known in the art. Metadata is generated to include the subjects of the media file.

At step 316, additional objects in the media file are identified. Objects such as a tree or a table may be identified using third party image analysis software known in the art. For example, a birthday party may include objects such as balloons, gifts, a cake, party hats, and the like. The image analysis software may identify objects by comparing objects in the media file to known or previously identified objects. Metadata is generated to include the objects of the media file.

At step 318, identification information is retrieved for the subjects and objects in the media file. The subjects and objects are compared to known or previously determined objects and subjects. Images of subjects may be stored in a user's contact list in order to identify a specific person, pet, or house. For example, a subject may be compared to stored images in the contact list to determine a match to a contact of the user. An image taken in New York City may have an object that is able to be identified as the Statue of Liberty. Metadata is generated to include the identification information for the subjects and objects.

At step 320, it is determined with whom the media file was shared. If the media file was attached to an email or a multimedia messaging service (MMS) message, or shared on a social networking site, the number of shares is determined and metadata is generated for the number of shares and with whom the media file was shared.

At step 322, the generated metadata is stored with the media file. The generated metadata from the image analysis and the metadata indicating whether the media file was pre-processed is stored with the media file.

At step 324, the media file and metadata are transmitted to the media sharing server, where it is stored. The method 300 ends at step 326.

FIG. 4 depicts a flow diagram of a method 400 for generating smart albums by comparing the metadata of a plurality of media files, according to one more embodiments. The method 400 generates a plurality of albums by comparing the metadata of media files. Media files with similar or identical metadata may be included in a same album. In addition, a single media file may be included in a plurality of albums. The order in which the albums are generated is purely exemplary. In addition, the types of albums that are generated are not meant to be limiting. Any albums may be generated based on media files with one or more pieces of matching information in their metadata. The albums may be generated in any order without taking away from the spirit of the invention. The method 400 starts at step 402 and proceeds to step 404.

At step 404, the metadata of the media files is compared to one another. Comparisons include, but are not limited to metadata that identifies a date/time/location compared to the identified date/time/location of metadata of other media files. Metadata that includes identified subjects is compared to identified subjects in other media files. Metadata that includes identified objects is compared to identified objects of other media files.

At step 406, a plurality of albums based on calendar events is generated. A calendar application on the user device is accessed in order to identify holidays or special dates such that albums may be created based on the calendar events. Special dates may include birthdays, anniversaries, and the like. Media files that were created on the date of a calendar event may be included in an album. In some embodiments, the title of the album is the event listed on the calendar, for example, Mother's Day 2016 or Labor Day 2016. The metadata of media files that were taken by other users and downloaded from the server is used to determine whether the media files were created on the specific calendar date, and in addition have an identified subject in common with the media file of the user. For example, a media file created by another user may have metadata that indicates that the pictures were taken on Mother's Day; however, the media file would only be included in the user's album if there were subjects in common, indicating that the other user attended the same Mother's Day event. Similar albums are made for other calendar events identified from the calendar application. In some embodiments, the media files are selected based on a specific timeframe on the date of the calendar event. For example, a New Year's Eve album may be generated to include media files taken between for example, 5 pm on New Year's Eve and 6 am on New Year's Day. A New Year's Day album may be generated to include media files taken between for example, 6 am and 11:59 pm on New Year's Day.

At step 406, albums that include a specific subject may be generated. For example, an album of selfies may be generated. For example, media files including metadata that indicates media files includes the user as the primary subject (e.g., more than 50% of the image is of the user's face) and possibly metadata indicating the image was taken with the front device camera are included in the selfie album. An album of smiling selfies may be generated that includes media files of the user associated with the user device that have been determined, based on the facial recognition software, to include the user as the primary subject and smiling. Similarly, an album of an identified subject is generated. For example, the metadata for a plurality of media files may indicate a same subject, for example a grandchild. An album of the identified subject may be generated.

At step 408, media files are organized into albums, for example a party album, where the metadata indicates that the media files include a same group of people, taken during a same timeframe, at a same location and further, where objects in the media files include objects such as balloons, party hats, gifts. Such objects indicate that the media files were created at a party. A birthday party album may be generated by detecting a same group of children in multiple users' photos at a same date, timeframe, and location and where the media file includes birthday items, such as gifts, party hats, cake, a piñata, and the like. Due to the fact that the media files were downloaded from the service provider server, the party albums include images and/or video taken by the user, as well as images and/or video taken by other attendees at the party.

At step 410, media files are organized into an album for example, a vacation album based on files created at a location away from a user's home over a period of days at a longitude and latitude associated with a vacation location. One or more vacation albums may be generated. For example, the metadata may indicate that a plurality of media files were generated at a location that is at least a pre-defined distance, for example 100 miles, away of the user's home location. In addition, it may be determined that the plurality of media files at said location was generated over a number of days. Further, the reverse geocode lookup may indicate a tourist location rather than a street address, for example, the Eiffel Tower. In some embodiments, image recognition software tags indicate a vacation destination. In some embodiments, a database of public locations may be accessed to retrieve additional media files of the vacation destination to include in the vacation album.

At step 412, a plurality of rolling albums may be generated. Rolling albums are albums that may be updated when new media files are stored on the user device. For example, an album of a user's 25 best photos may be generated, where the best photos are determined based on image recognition software, giving higher weight to more recent photos. Other albums may be generated, for example an album of the last 25 media files created. Any albums may be generated based on similar information stored in the metadata of media files. The method 400 ends at step 414.

FIG. 5 depicts a computer system 500 that can be utilized in various embodiments of the present invention to implement the computer and/or the display, according to one or more embodiments.

Various embodiments of method and apparatus for a smart album generator, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement the methods 200, 300, and 400 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the operations described with respect to FIG. 2, FIG. 3, and FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined.

1. A computer implemented method for generating smart albums comprising:
performing image analysis on a plurality of media files on a first user device, wherein each of the plurality of media files includes metadata;
updating metadata associated with each of the plurality of media files based on the image analysis;
transmitting the plurality of media files and updated metadata to a media sharing server;
receiving, in response to transmitting the plurality of media files, one or more media files created by other users, wherein the metadata associated with the received media files is similar to the metadata associated with the transmitted media files; and
generating a plurality of albums based on a comparison of metadata of the transmitted and received media files.

2. The method of claim 1, wherein a media file is one of an image or a video.

3. The method of claim 1, further comprising performing a reverse geocode lookup for a latitude and a longitude in the metadata of each of the plurality of media files.

4. The method of claim 1, wherein performing image analysis comprises determining a value associated with an image quality of the media file.

5. The method of claim 1, wherein performing image analysis comprises performing facial analysis to determine a number of faces in the media file, and a sex and age estimation of each of the faces in the media file.

6. The method of claim 1, wherein performing image analysis comprises determining one or more subjects in each of the media files.

7. The method of claim 6, further comprising retrieving identification information for one or more subjects in each of the plurality of media files.

8. The method of claim 1, further comprising determining a number of times a media file was shared via multimedia message service or email.

9. The method of claim 1, wherein generating a plurality of albums comprises at least one of:
identifying a plurality of media files with metadata that indicates the media files were created at a same date, a same time, a same location, and include one or more of the same subjects;
identifying a plurality of media files with metadata that indicates the media files include a same one or more subjects;
identifying a plurality of media files with metadata that indicates the media files having the highest image quality value;
identifying a plurality of media files with metadata that indicates the media files were created at a location outside of a predefined distance from a home address of a user, and wherein the dates the media files were created are within a predefined timeframe; and
identifying a plurality of media files with metadata that indicates the media files were created on a date associated with a calendar event stored in a calendar application on the user device.

10. An apparatus for generating smart albums comprising:
a) at least one processor;
b) at least one input device; and
c) at least one storage device storing processor-executable instructions which, when executed by the at least one processor, perform a method including:
performing image analysis on a plurality of media files on a first user device, wherein each of the plurality of media files includes metadata;
updating metadata associated with each of the plurality of media files based on the image analysis;
transmitting the plurality of media files and updated metadata to a media sharing server;
receiving, in response to transmitting the plurality of media files, one or more media files created by other users, wherein the metadata associated with the received media files is similar to the metadata associated with the transmitted media files; and
generating a plurality of albums based on a comparison of metadata of the transmitted and received media files.

11. The apparatus of claim 10, wherein a media file is one of an image or a video.

12. The apparatus of claim 10, further comprising performing a reverse geocode lookup for latitude and a longitude in the metadata of each of the plurality of media files.

13. The apparatus of claim 10, wherein performing image analysis comprises determining a value associated with an image quality of the media file.

14. The apparatus of claim 10, wherein performing image analysis comprises performing facial analysis to determine a number of faces in the media file, and a sex and age estimation of each of the faces in the media file.

15. The apparatus of claim 10, wherein performing image analysis comprising determining one or more subjects in each of the media files.

16. The apparatus of claim 15, further comprising retrieving identification information for one or more subjects in each of the plurality of media files.

17. The apparatus of claim 10, further comprising determining a number of times a media file was shared via multimedia message service or email.

18. The apparatus of claim 10, wherein generating a plurality of albums comprises at least one of:
identifying a plurality of media files with metadata that indicates the media files were created at a same date, in a same timeframe, a same location, and include one or more of the same subjects;
identifying a plurality of media files with metadata that indicates the media files include a same one or more subjects;
identifying a plurality of media files with metadata that indicates the media files having the highest image quality value;
identifying a plurality of media files with metadata that indicates the media files were created at a location outside of a predefined distance from a home address of a user, and wherein the dates the media files were created are within a predefined timeframe; and
identifying a plurality of media files with metadata that indicates the media files were created on a date associated with a calendar event stored in a calendar application on the user device.

19. A non-transitory computer readable medium for storing computer instructions that, when executed by at least one processor causes the at least one processor to perform a method for generating smart albums comprising:
performing image analysis on a plurality of media files on a first user device, wherein each of the plurality of media files includes metadata;
updating metadata associated with each of the plurality of media files based on the image analysis;
transmitting the plurality of media files and updated metadata to a media sharing server;
receiving, in response to transmitting the plurality of media files, one or more media files created by other users, wherein the metadata associated with the received media files is similar to the metadata associated with the transmitted media files; and
generating a plurality of albums based on a comparison of metadata of the transmitted and received media files.

20. The non-transitory computer readable medium of claim 19, wherein generating a plurality of albums comprises at least one of:
identifying a plurality of media files with metadata that indicates the media files were created at a same date, in a same timeframe, a same location, and include one or more of the same subjects;
identifying a plurality of media files with metadata that indicates the media files include a same one or more subjects;
identifying a plurality of media files with metadata that indicates the media files having the highest image quality value;
identifying a plurality of media files with metadata that indicates the media files were created at a location outside of a predefined distance from a home address of a user, and wherein the dates the media files were created are within a predefined timeframe; and
identifying a plurality of media files with metadata that indicates the media files were created on a date associated with a calendar event stored in a calendar application on the user device.
